(19) United States
(12) Patent Application Publication
(10) Pub. No.: US 2008/0005015 A1
(43) Pub. Date: Jan. 3, 2008

(54) SYSTEM AND METHOD FOR AGGREGATING MORTGAGE AND SALES DATA FOR GENERATING, ASSESSING AND QUALIFYING MORTGAGE LEADS

(76) Inventors: Houcine Z. Abadlia, Weston, FL (US); Constance J. Leon, Hallandale Beach, FL (US); Evan S. Benrubi, Hollywood, FL (US); Marcos C. Lopes, Coconut Creek, FL (US); Leo Martinez, Miami, FL (US)

Correspondence Address: Ketan S. Vakil;SNELL & WILMER L.L.P., Suite 1400, 600 Anton Boulevard, Costa Mesa, CA, 92626-7689, US

(21) Appl. No.: 11/771,936

(22) Filed: Jun. 29, 2007

Related U.S. Application Data
(60) Provisional application No. 60/817,265, filed on Jun. 29, 2006.

(51) Int. Cl. G06Q 40/00

(52) U.S. Cl. 705/38

(57) ABSTRACT

The invention relates to mortgage and sales data assessment and more specifically to a system and method for aggregating mortgage and sales data for generating, assessing, and qualifying mortgage leads. The method for generating a table of mortgage leads comprising storing a plurality of mortgage leads in a database wherein each mortgage lead of the plurality of mortgage leads has a plurality of data of a plurality of data types including a data of a first data type, storing the relationships between the plurality of data of the plurality of data types in a fact table, selecting the first data type to organize the plurality of mortgage leads, and generating a table of mortgage leads wherein the plurality of mortgage leads are organized by the data of the first data type using the fact table.

### CLAIM OF PRIORITY UNDER 35 U.S.C. §119

The present Application for Patent claims priority to U.S. Provisional Application No. 60/817,265, entitled “CDS Mart—Mortgage Marketing Leads System,” filed on Jun. 29, 2006, and assigned to the assignee hereof and hereby expressly incorporated by reference herein.

### BACKGROUND

1. Field

The invention relates to mortgage and sales data assessment and more specifically to a system and method for aggregating mortgage and sales data for generating, assessing, and qualifying mortgage leads.

2. Related Art

A mortgage lead is information on a person who is seeking to take out a mortgage, typically either for a new home or to refinance their home. One way of generating these leads is to solicit potential borrowers to fill out a questionnaire indicating their willingness to take out a new mortgage or refinance their existing mortgage. Another way of generating leads is to take information from public records data about real property and solicit customers who may potentially refinance their real property. However, reviewing public records data to determine which customers may refinance their real property is a difficult and time consuming task. Hence, there is a need for a system and method for evaluating the public records data so that lenders can identify leads with the highest probability of becoming closed mortgage deals.

One solution that has been developed includes a large Excel spreadsheet of summarized public records data. However, the public records data cannot be easily accessed by a sales force via the Internet, is not flexible, and is cumbersome to use. Thus, there is a need for a system and method that is easily accessible by a sales force via the Internet, is flexible enough to assess and qualify leads in real time, and easy to use.

### SUMMARY

In one embodiment, the invention is a method for generating a table of mortgage leads comprising storing a plurality of mortgage leads in a database wherein each mortgage lead of the plurality of mortgage leads has a plurality of data of a plurality of data types including a data of a first data type, storing the relationships between the plurality of data of the plurality of data types in a fact table, selecting the first data type to organize the plurality of mortgage leads, and generating a table of mortgage leads wherein the plurality of mortgage leads are organized by the data of the first data type using the fact table.

In one embodiment, the invention is a method for generating a list of qualified mortgage leads comprising storing a plurality of mortgage leads in a database wherein each mortgage lead of the plurality of mortgage leads has a plurality of data of a plurality of data types including a data of a first data type, storing the relationships between the plurality of data of the plurality of data types in a fact table, inputting a first qualifying data of the first data type in an interface, and generating a table of mortgage leads wherein the mortgage leads have data of the first data type that match the first qualifying data of the first data type using the fact table.

In one embodiment, the invention is a method for qualifying a mortgage lead comprising storing a plurality of mortgage leads in a database wherein each mortgage lead of the plurality of mortgage leads has a plurality of data of a plurality of data types including a data of a first data type, storing the relationships between the plurality of data of the plurality of data types in a fact table, selecting a mortgage lead from the plurality of mortgage leads, inputting a qualifying data of the first data type in an interface, and qualifying the selected mortgage lead based on whether the data of the first data type of the selected mortgage lead matches the qualifying data of the first data type using the fact table.

### BRIEF DESCRIPTION OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 is a schematic diagram of a mortgage lead system according to an embodiment of the invention.

FIG. 2 is a detailed schematic diagram of the database of FIG. 1 according to an embodiment of the invention.

FIG. 3 is an interface displaying sample data types 10(a)-10(n) and sample data 12(a)-12(n) according to an embodiment of the invention.

FIG. 4 is an interface displaying sample data 12(a)-12(n) according to an embodiment of the invention.

FIG. 5 is an interface displaying a sample fact table according to an embodiment of the invention.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “one embodiment” or “an embodiment” in various places in the specification are not necessarily all referring to the same embodiment. Throughout the drawings, reference numbers are re-used to indicate correspondence between referenced elements. The invention can also be embodied on machine readable mediums such as RAM, ROM, hard drives, cache memory, compact discs, DVDs, memory sticks, etc.

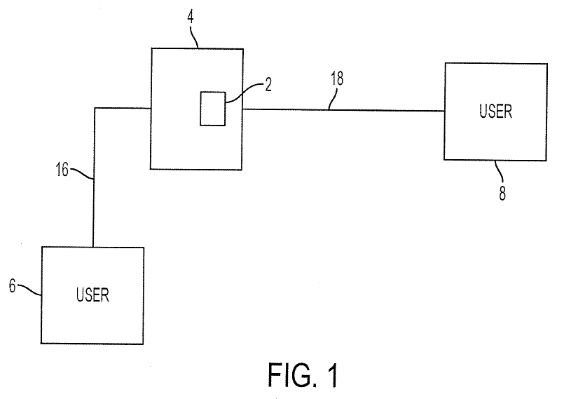

FIG. 1 is a schematic diagram of a mortgage lead system according to an embodiment of the invention. The mortgage lead system may include a processing device 4 (e.g., a computer, a hand-held device, a personal digital assistant, a cell phone, etc.) having a storage device 2 (e.g., a database). For illustrative purposes, the processing device 4 will be referred to as a computer 4 and the storage device 2 will be referred to as a database 2.

The database 2 may reside on the computer 4 or may be coupled to the computer 4. The database 2 stores data such as mortgage data, employment data, sports data, etc. for a particular mortgage customer or property. A user 6 can use a processing device via the connection 16 to review and update the data (e.g., add and remove mortgage data) in the database 2. The connection 16 can be a wired or wireless connection and can include a distributed network or the Internet. The user 6 can also access the database 2 from a remote location. The remote location can be, for example, in a remote location such as a different office in an office building, a client site, a library, etc.

A user 8 can use a processing device via the connection 18 to review and use the data in the database 2. The connection 18 can be a wired or wireless connection and can include a distributed network or the Internet. The user 8 can also access the database 2 from a remote location. The remote location can be, for example, in a remote location such as a different office in an office building, a client site, a library, etc. The users 6 and 8 can be two separate individuals or the same individual.

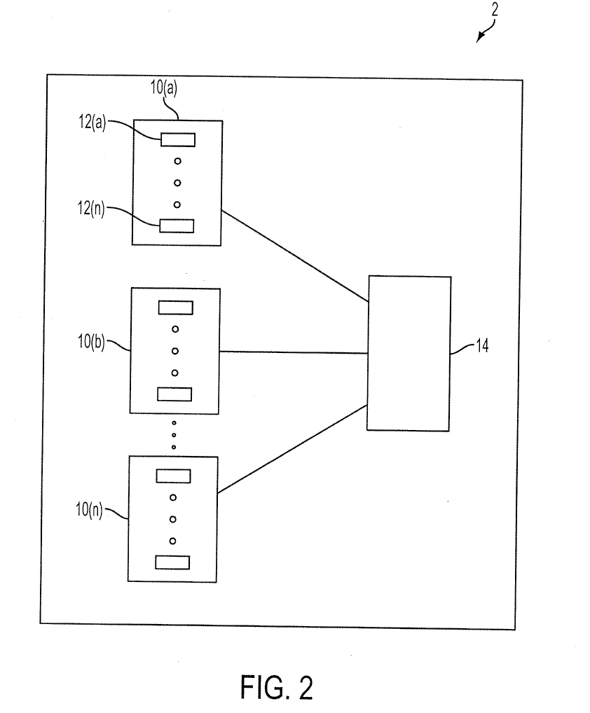

FIG. 2 is a detailed schematic diagram of the database 2 of FIG. 1 according to an embodiment of the invention. The database 2 has a plurality of data types 10(a)-10(n). Each of the plurality of data types 10(a)-10(n) can have a plurality of data 12(a)-12(n). The database 2 may also include a fact table 14, which keeps track of the relationships between each of the plurality of data types 10(a)-10(n). For example, the fact table 14 is a description or outline showing the relationship between a first data type 10(a) and a second data type 10(b).

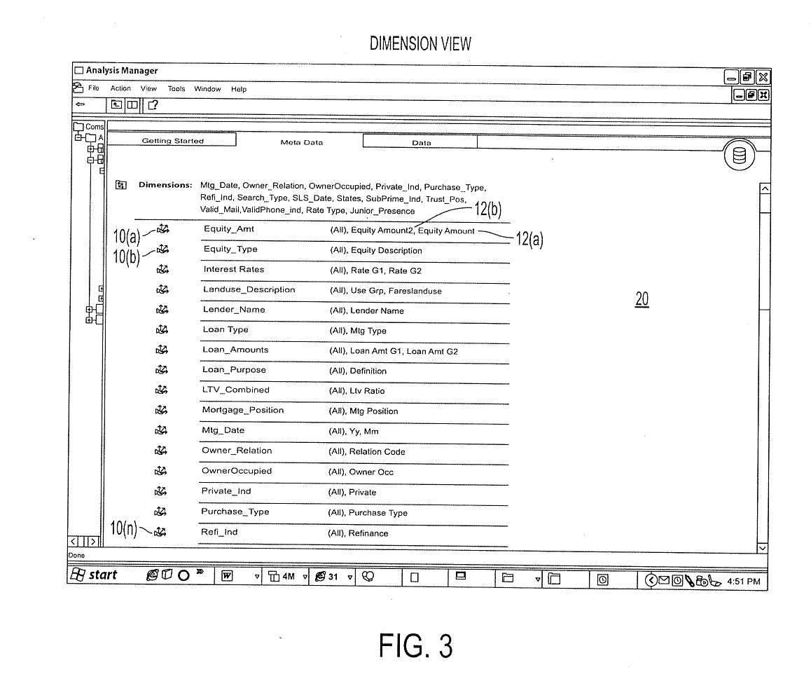

FIG. 3 is an interface 20 displaying sample data types 10(a)-10(n) and sample data 12(a)-12(n) according to an embodiment of the invention. The interface 20 may be a graphical user interface generated by the computer 4. The interface 20 can be displayed on the screen of a computer or a hand-held device by the users 6 and 8. The data type 10(a) is Equity Amount and the data type 10(b) is Equity Type. The data type 10(a) has two pieces of data 12(a) and 12(b). The data 12(a) is a first data on equity amount and the data 12(b) is a second data on equity amount.

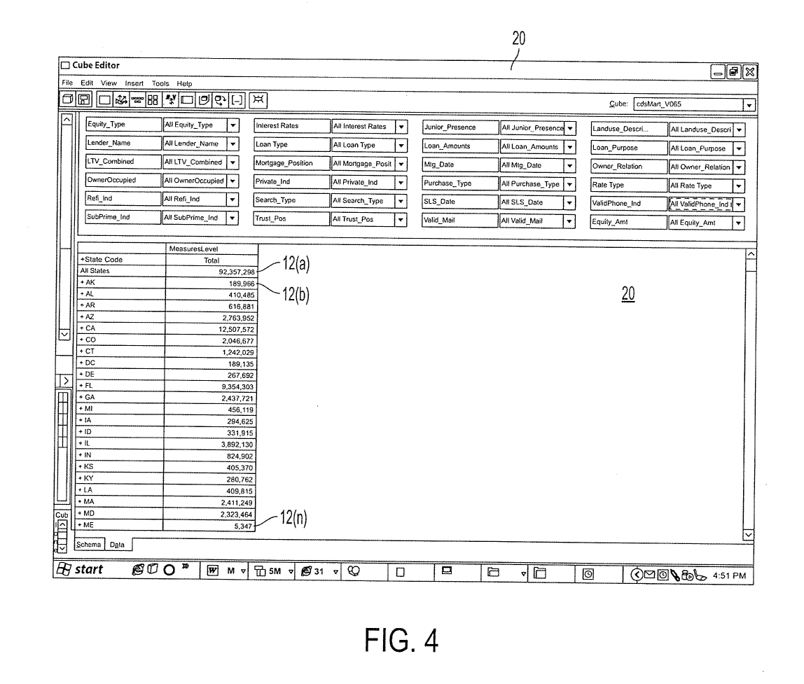

FIG. 4 is an interface 20 displaying sample data 12(a)-12(n) according to an embodiment of the invention. The data 12(a)-12(n) represent statistical data from states across the country such as Alaska, Alabama, Arkansas, Arizona, California, etc.

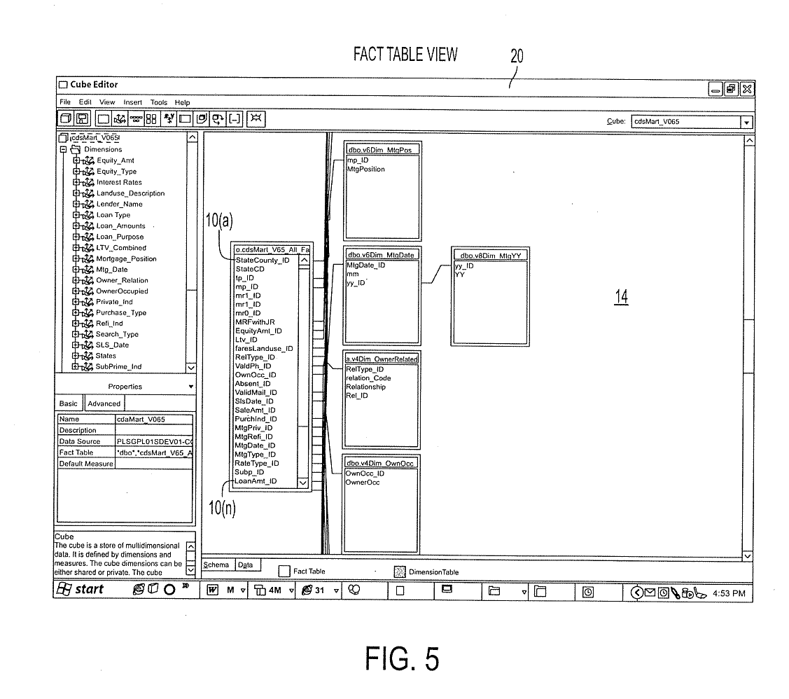

FIG. 5 is an interface 20 displaying a sample fact table 14 according to an embodiment of the invention. The fact table 20 shows the relationships between the data types 10(a)-10(n).

The invention can use Online Analytical Processing (OLAP) and Microsoft Office web components, such as Active X controls, to create the database 2, develop queries for accessing and assessing the data in real time, and to develop a graphical user interface 20. The data 12(a)-12(n) from public record databases on real property is collected and organized into categories by data type 10(a)-10(n). The data 12(a)-12(n) is stored in a relational database such as the database 2.

The invention allows a user to access and reorganize data in real time, which is important to a salesperson on a sales call that needs instant information on a prospective borrower. The invention can also assess and qualify a lead in real time to assist the salesperson in closing a mortgage deal. The invention may use one or more categories and/or data types to assess and qualify a lead. For example, while on a sales call, a salesperson may discover that a potential borrower has a very low credit score and thus would not qualify for a mortgage. The salesperson may decide that he needs to qualify a mortgage lead. The salesperson can select the mortgage lead to qualify and input the qualifying data of the first data type in the graphical user interface 20. The invention can determine if the data of the first data type matches the qualifying data of the first data type using the fact table 14.

As an example, the user can determine that in order to qualify the mortgage lead, the personal income has to be above $85,000. The user can select the mortgage lead, input $85,000 for the personal income and select it as being greater than $85,000. The invention can then determine if the personal income of the mortgage lead is a match, which in this case means that the mortgage lead has a personal income level greater than $85,000. If there is a match, then the mortgage lead would be qualified. If, however, there is no match, then the mortgage lead would not be qualified.

The user can also determine that there needs to be other matches necessary to qualify a mortgage lead. For example, the user can determine that the mortgage lead needs to have a mortgage amount of under $400,000 in addition to a personal income of above $85,000. The user can enter $400,000 for the mortgage amount and select less than and enter $85,000 for the personal income level and select greater than. Thus, there will be a match if the personal income level is greater than $85,000 and the mortgage amount is less than $400,000 for the mortgage lead. Otherwise, there will be no match.

In one embodiment, the user can pre-specify the criteria necessary for qualifying the mortgage lead. Thus, the user can already pre-specify that the personal income level of the mortgage lead needs to be above $85,000 and the mortgage amount needs to be less than $400,000. Thus, the user only has to select a button to determine if the mortgage lead is qualified or not. Furthermore, the invention can determine if the mortgage lead is qualified or not substantially, contemporaneously with the entry of data of the mortgage lead by the salesperson or user.

The invention can generate mortgage leads by using one or more categories and/or data types. For example, the user may look at interest rates and target property owners whose mortgages have high interest rates and then try to solicit these property owners by offering to refinance their mortgage at a lower interest rate. To accomplish this, the user may select the interest rate data type. A list of mortgage leads can then be generated from highest to lowest or lowest to highest interest rates. Alternatively, the user can input an interest rate such as 8% and select higher. Then, a list of mortgage leads can be generated which have interest rates that are higher than 8%.

The OLAP cube may be composed of the fact table 14, a plurality of data types 10(a)-10(n), and a plurality of data 12(a)-12(n) for each of the plurality of data types 10(a)-10(n). The plurality of data types 10(a)-10(n) can be dimensions and the plurality of data 12(a)-12(n) can be a plurality of measures. Thus, the OLAP cube may be composed of the fact table 14, the plurality of dimensions 10(a)-10(n), and the plurality of measures 12(a)-12(n). Thus, the invention may employ a MOLAP cube for use of multiple dimensions.

The fact table 14 may be an index to the dimensions and tie the dimensions together. A measure is a numeric value depicting a volume or total, such as the sum of all units, the number of meetings or the number of sales. A dimension is a hierarchical structure of related data groupings, such as time, geography, or products. These dimensions are based on commonly requested search criteria. After the dimension, the fact table and the measure have been identified, the invention uses a structural query language (SQL) to create the dimensions.

This invention may use one or more of the thirty-two dimensions, which may include:
1. Geography
2. Combined Loan Amount
3. Combined LTV
4. Equity Amount
5. Equity Type
6. Ethnicity
7. Fares Landuse
8. Interest Rates
9. Junior Presence
10. Lender Name
11. Loan Amounts
12. Loan Type
13. Mortgage Date
14. Mortgage Date Month
15. Mortgage History Count
16. Mortgage Position
17. Mortgage Term
18. Owner Relation
19. Owner Occupied
20. Private Mortgage Indicator
21. Rate Type
22. Sales Date
23. Search Type
24. SubPrime Indicator
25. Trust Position
26. Valid Mail
27. Valid Phone
28. VP4 Value
29. Loan Purpose
30. Parceled
31. Purchase Refinance Indicator
32. Total Measure

The invention may use Microsoft Office web components with pivot table capabilities, which allow the invention to be deployed as an Excel spreadsheet, a hypertext markup language (HTML) website, an active server page (ASP) or a SQL reporting services report. The OLAP data can be accessed directly using the multidimensional expressions (MDX) query language. The invention can be accessed by a client machine accessing a web server that hosts the data source for the cube. The web server can then access the SQL server database and return the results back to the web server, which then returns the results to the client machine.

The invention allows the user to use a web browser, such as Microsoft Internet Explorer, to access the invention through a link to the graphical user interface 20. From the graphical user interface 20, the user can use a series of drop down menus to choose between the different dimensions 10(a)-10(n) and to navigate through the hierarchies of the dimensions to select relevant criteria used to generate, assess, or qualify a mortgage lead.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for generating a table of mortgage leads comprising:
storing a plurality of mortgage leads in a database, each mortgage lead of the plurality of mortgage leads having a plurality of data of a plurality of data types including a data of a first data type;
storing the relationships between the plurality of data of the plurality of data types in a fact table;
selecting the first data type to organize the plurality of mortgage leads; and
generating a table of mortgage leads wherein the plurality of mortgage leads are organized by the data of the first data type using the fact table.

2. The method of claim 1 further comprising selecting a second data type to organize the plurality of mortgage leads.

3. The method of claim 2 further comprising generating a table of mortgage leads wherein the mortgage leads are organized by the data of the first data type and the data of the second data type using the fact table.

4. The method of claim 1 wherein the plurality of data types is a plurality of dimensions and the plurality of data is a plurality of measures.

5. The method of claim 4 wherein the plurality of dimensions are selected from a group consisting of a Geography, Combined Loan Amount, Combined LTV, Equity Amount, Equity Type, Ethnicity, Fares Landuse, Interest Rates, Junior Presence, Lender Name, Loan Amounts, Loan Type, Mortgage Date, Mortgage Date Month, Mortgage History Count, Mortgage Position, Mortgage Term, Owner Relation, Owner Occupied, Private Mortgage Indicator, Rate Type, Sales Date, Search Type, SubPrime Indicator, Trust Position, Valid Mail, Valid Phone, VP4 Value, Loan Purpose, Parceled, Purchase Refinance Indicator, Total Measure, and combinations thereof.

6. The method of claim 1 wherein the fact table is an index of the plurality of data types and an index of the plurality of data.

7. A method for generating a list of qualified mortgage leads comprising:
storing a plurality of mortgage leads in a database wherein each mortgage lead of the plurality of mortgage leads has a plurality of data of a plurality of data types including a data of a first data type;
storing the relationships between the plurality of data of the plurality of data types in a fact table;
receiving a first qualifying data of the first data type; and
generating a table of mortgage leads wherein the mortgage leads have data of the first data type that match the first qualifying data of the first data type using the fact table.

8. The method of claim 7 further comprising receiving a first qualifying data of a second data type.

9. The method of claim 8 further comprising generating a table of mortgage leads wherein the mortgage leads have data of the first data type that match the first qualifying data of the first data type and data of the second data type that match the first qualifying data of the second data type using the fact table.

10. The method of claim 7 wherein the plurality of data types is a plurality of dimensions and the plurality of data is a plurality of measures.

11. The method of claim 10 wherein the plurality of dimensions are selected from a group consisting of a Geography, Combined Loan Amount, Combined LTV, Equity Amount, Equity Type, Ethnicity, Fares Landuse, Interest Rates, Junior Presence, Lender Name, Loan Amounts, Loan Type, Mortgage Date, Mortgage Date Month, Mortgage History Count, Mortgage Position, Mortgage Term, Owner Relation, Owner Occupied, Private Mortgage Indicator, Rate Type, Sales Date, Search Type, SubPrime Indicator, Trust Position, Valid Mail, Valid Phone, VP4 Value, Loan Purpose, Parceled, Purchase Refinance Indicator, Total Measure, and combinations thereof.

12. The method of claim 7 wherein the fact table is an index of the plurality of data types and an index of the plurality of data.

13. The method of claim 7 wherein the fact table keeps track of the relationships between each of the plurality of data types.

14. A method for qualifying a mortgage lead comprising:
storing a plurality of mortgage leads in a database wherein each mortgage lead of the plurality of mortgage leads has a plurality of data of a plurality of data types including a data of a first data type;
storing the relationships between the plurality of data of the plurality of data types in a fact table;
selecting a mortgage lead from the plurality of mortgage leads;
receiving a qualifying data of the first data type; and
qualifying the selected mortgage lead based on whether the data of the first data type of the selected mortgage lead matches the qualifying data of the first data type using the fact table.

15. The method of claim 14 further comprising receiving a qualifying data of the second data type.

16. The method of claim 15 further comprising qualifying the selected mortgage lead based on whether the data of the first data type of the selected mortgage lead matches the qualifying data of the first data type and whether a data of the second data type of the selected mortgage lead matches the qualifying data of the second data type.

17. The method of claim 14 wherein the plurality of data types is a plurality of dimensions and the plurality of data is a plurality of measures.

18. The method of claim 17 wherein the plurality of dimensions are selected from a group consisting of a Geography, Combined Loan Amount, Combined LTV, Equity Amount, Equity Type, Ethnicity, Fares Landuse, Interest Rates, Junior Presence, Lender Name, Loan Amounts, Loan Type, Mortgage Date, Mortgage Date Month, Mortgage History Count, Mortgage Position, Mortgage Term, Owner Relation, Owner Occupied, Private Mortgage Indicator, Rate Type, Sales Date, Search Type, SubPrime Indicator, Trust Position, Valid Mail, Valid Phone, VP4 Value, Loan Purpose, Parceled, Purchase Refinance Indicator, Total Measure, and combinations thereof.

19. The method of claim 14 wherein the fact table is an index of the plurality of data types and an index of the plurality of data.

20. The method of claim 14 wherein the fact table keeps track of the relationships between each of the plurality of data types.
